(19) United States
(12) Patent Application Publication
(10) Pub. No.: US 2024/0185041 A1
(43) Pub. Date: Jun. 6, 2024

(54) METHOD FOR PROCESSING ACTION USING RANK GRAPH CONVOLUTIONAL NETWORK AND APPARATUS THEREOF

(71) Applicants: KOREA INSTITUTE OF SCIENCE AND TECHNOLOGY, Seoul (KR); SOGANG UNIVERSITY RESEARCH & BUSINESS DEVELOPMENT FOUNDATION, Seoul (KR)

(72) Inventors: Junghyun CHO, Seoul (KR); Igjae KIM, Seoul (KR); Unsang PARK, Seoul (KR); Haetsal LEE, Seoul (KR)

(73) Assignees: KOREA INSTITUTE OF SCIENCE AND TECHNOLOGY, Seoul (KR); SOGANG UNIVERSITY RESEARCH & BUSINESS DEVELOPMENT FOUNDATION, Seoul (KR)

(21) Appl. No.: 18/450,833

(22) Filed: Aug. 16, 2023

(30) Foreign Application Priority Data
Dec. 1, 2022 (KR) 10-2022-0165732

(51) Int. Cl. G06N 3/0464; G06N 3/048

(52) U.S. Cl. CPC G06N 3/0464; G06N 3/048

(57) ABSTRACT

The present disclosure relates to a technology for skeleton-based action recognition based on a graph convolutional network, in which an action processing device receives a frame including a skeleton with respect to actions of an object, extracts spatiotemporal features with respect to the skeleton by using a rank adjacency matrix in which a distance between one node and another node and an adjacency ranking are considered, merges an object and vertices in the input frame based on the extracted spatiotemporal features, and performs a classification task.

### CROSS-REFERENCE TO RELATED APPLICATIONS

This application claims the benefit under 35 USC 119(a) of Korean Patent Application No. 10-2022-0165732 filed on Dec. 1, 2022, in the Korean Intellectual Property Office, the entire disclosure of which is incorporated herein by reference for all purposes.

### BACKGROUND

### Field

The present disclosure relates to a technology for action recognition, and, more particularly, to a skeleton-based method of recognizing actions based on a graph convolutional network and an apparatus thereof.

### Related Art

Action recognition has become a very important task in computer vision and artificial intelligence. This is because action recognition is widely used in various applications, such as human-computer interaction, gaming, video surveillance, and video understanding. As the spread of infectious diseases such as COVID-19 increases the amount of time spent at home, a home training system by action recognition is in greater demand. In addition, the scope of application of action recognition is expanding to the action recognition for companion animals.

Depending on the type of input data used, methods of action recognition are roughly categorized into image-based, skeleton-based, and hybrid approaches. In the image-based approach, optical flows, which refer to point correspondences across pairs of images, have been commonly used to represent the apparent actions of subjects of interest. However, this method often requires time-consuming and storage-demanding subprocesses. In addition, the performance of the image-based method can be affected by optical noises such as illuminations. Even if these issues are mitigated, the image-based approach is not free from personally identifiable information (PII) issues. In real situations, such as hospital services for elderly patients, the application of this approach is limited.

In this context, the advantages of the skeleton-based approach are clear. As optical flows are extracted in the image-based approach, the process of extracting skeletons, which refer to sets of connected coordinates to describe poses of an interested subject, is performed by videos. However, this type of method is relatively lightweight because its representations are compact and privacy-free. The prevalence of cost-effective depth sensors such as Microsoft Kinect and decent pose predictors such as Openpose has made it easier to obtain skeleton data for the methods of action recognition.

In the study on skeleton-based action recognition at an early stage, pseudo images were generated from skeleton sequences, or heatmaps were obtained from pose prediction models, e.g., convolutional neural networks (CNNs). These approaches are similar to the image-based method. However, creating an intermediate form of data such as pseudo images conflicts with compactly using skeleton data and hinders the learning of deeper neural networks on low-end computers. Therefore, graph convolutional networks (GCNs), in which the CNNs are generalized to more general graph structures, have been selected for the skeleton-based action recognition.

### SUMMARY

The purpose of the embodiments of the present disclosure is to solve the problem of the conventional graph-based technology for action recognition that the accuracy of action recognition is reduced or vulnerability to graph noise is caused by following a randomly determined rule or calculating using a learning parameter when calculating an adjacency matrix for one node.

To achieve the aforementioned purpose, an embodiment of the present disclosure provides a method of processing actions based on a graph convolutional network (GCN), including: a step in which an action processing device receives a frame including a skeleton with respect to actions of an object; a step in which the action processing device extracts spatiotemporal features with respect to the skeleton by using a rank adjacency matrix in which a distance between one node and another node and an adjacency ranking are considered; a step in which the action processing device merges an object and vertices in the input frame based on the extracted spatiotemporal features; and a step in which the action processing device performs a classification task.

An embodiment of the present disclosure provides the method of processing actions, wherein the step of extracting the spatiotemporal features is carried out by a module including at least one spatial graph convolutional layer and at least one temporal convolutional layer, and the spatial graph convolutional layer performs node indexing along a feature channel axis, applies a fully-connected layer, aggregates vertices using a rank adjacency matrix, and applies an attention mask shared between frames.

An embodiment of the present disclosure provides the method of processing actions, wherein the rank adjacency matrix generates a matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric.

Furthermore, a computer-readable recording medium in which a program for executing the above-described method of processing actions in a computer is recorded will be described below.

To achieve the aforementioned purpose, an embodiment of the present disclosure provides an action processing device including: an input unit receiving a frame including a skeleton with respect to actions of an object; and a processing unit processing actions in the frame by using a graph convolutional network (GCN), wherein the processing unit extracts spatiotemporal features with respect to the skeleton by using a rank adjacency matrix in which a distance between one node and another node and an adjacency ranking are considered, merges an object and vertices in an input frame based on the extracted spatiotemporal features, and performs a classification task.

An embodiment of the present disclosure provides the action processing device, wherein the processing unit extracts the spatiotemporal features using a module including at least one spatial graph convolutional layer and at least one temporal convolutional layer, and the spatial graph convolutional layer performs node indexing along a feature channel axis, applies a fully-connected layer, aggregates vertices using a rank adjacency matrix, and applies an attention mask shared between frames.

An embodiment of the present disclosure provides the action processing device, wherein the processing unit generates the rank adjacency matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric.

According to the embodiments of the present disclosure described above, there has been proposed the Rank-GCN in which a rank adjacency matrix is derived based on a distance between one node and other nodes and an adjacency ranking in order to apply a GCN architecture to action recognition. The Rank-GCN may be a method in which a rank adjacency graph is defined based on pairwise distances between vertices and vertex features are accumulated according to a rank with the shortest distance and a rank with the longest distance. As a result, in the case of the Rank-GCN, not only the accuracy in action recognition may be improved, but also the robustness for swapping, moving, and dropping of a specific node may be secured in a more practical scenario.

### BRIEF DESCRIPTION OF THE DRAWINGS

FIG. 1 illustrates two situations in which inaccurate skeleton information can affect the accuracy of action recognition.

FIG. 2 illustrates an overall model structure for action recognition based on a rank graph convolutional network according to the embodiments of the present disclosure.

FIG. 3 is a flowchart illustrating a method of processing actions based on a graph convolutional network (GCN) according to an embodiment of the present disclosure.

FIG. 4 is a view illustrating a comparison of various methods of defining adjacent neighbors in order to explain the concept of “ranking” according to the embodiments of the present disclosure.

FIG. 5 illustrates in more detail a rank graph convolutional layer of the action recognition model in FIG. 2.

FIG. 6 is a view for explaining a process of generating a rank adjacency matrix.

FIG. 7 illustrates in more detail an operation process for each frame of the rank graph convolutional layer in FIG. 5.

FIGS. 8 and 9 are views for explaining a process of performing a rank graph convolutional layer and for illustrating pseudocodes, respectively.

FIG. 10 is a block diagram illustrating an action processing device based on a graph convolutional network according to an embodiment of the present disclosure.

FIG. 11 is a view illustrating three experimental setups for a robustness test.

FIGS. 12 to 17 show graphs illustrating the results of the robustness test in FIG. 11.

### DESCRIPTION OF EXEMPLARY EMBODIMENTS

Prior to describing the embodiments of the present disclosure in detail, problems recognized in the field of action recognition technology in which the embodiments of the present disclosure are implemented and technical means that can be considered to resolve the problems are sequentially described.

Graph convolutional networks (GCN) learn features at a vertex (i.e., a joint of a skeleton) by aggregating features over neighboring vertices on the top of an irregular graph that is constructed with 2D or 3D joint coordinates as nodes and their connections (i.e., bones) as edges, with respect to both the spatial and temporal dimensions of input data. According to this aggregation strategy, various methods can be distinguished. For simplicity, physical connectivity between body joints has been used, but, for the ideal feature aggregation strategy, long-range dependencies between nodes having strong correlations even if being structurally apart should be reflected beyond local neighborhoods and reflect. Hence, the previously developed methods are implying methods in which neighboring vertices are predefined heuristically and adjacency information is learned from data.

However, even if global neighbors are used, the adjacency information is usually fixed over the temporal dimension of an input video, and skeleton-based methods are sensitive noise in joint coordinates, just as image-based methods are sensitive to optical noise.

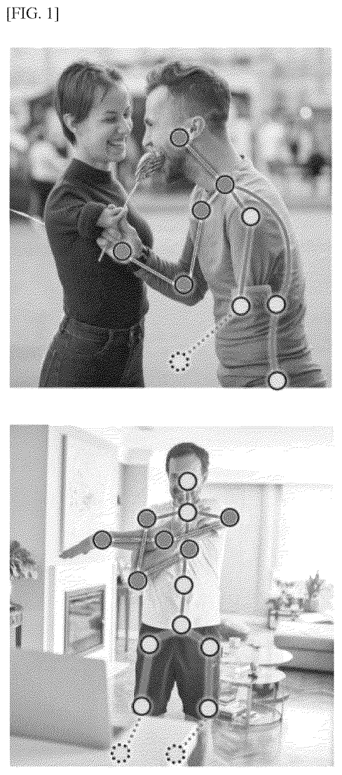

FIG. 1 shows two example situations in which inaccurate skeleton information can affect action recognition performance. The picture on the left illustrates a person with one arm sharing a candy, and the picture on the right shows a person stretching his arms in front of a desk. In both cases, the dotted circles and lines are inevitably shifted and show inaccurate skeleton information. To solve such a problem, according to the embodiments of the present disclosure, there is provided technical means for increasing robustness by focusing on positions where actions are actually made (the yellow circles and lines) in a dynamic and physically meaningful manner.

According to the embodiments of the present disclosure below, there may be provided an effective but robust framework, a rank graph convolutional network (Rank-GCN), which calculates an adjacency matrix dynamically along the temporal dimension. The main goals of the proposed embodiments are as follows.

By the Rank-GCN, a new method where global information is used in both the spatial and temporal dimensions may be proposed. Compared to the conventional methods in which learnable parameters are used to generate a dynamic adjacency matrix, the Rank-GCN may have fewer parameters, be easier to implement, and produce more interpretable results. Human-made methods have been recognized as weaker than deep learning-based methods, but the approach of the Rank-GCN may not only show better performance than the existing methods but also have interpretable prospects.

The issue of calculating adjacency matrices may be addressed by using the geometrical distance measure and introducing a rank graph convolution algorithm. For example, instead of using distance thresholds directly, distance rankings may be used. By using the ranks to determine adjacent groups of joints, neighboring nodes may be better utilized, and, in activity recognition, better performance and robustness may be secured compared to the state-of-the-art methods.

Hereinafter, the embodiments of the present disclosure will be described in detail with reference to the accompanying drawings. However, in relation to the following description and accompanying drawings, detailed descriptions of well-known functions or features that may obscure the gist of the embodiments will not be provided. In addition, throughout the disclosure, “comprising” a certain component means that other components may be further comprised, not that other components are excluded, unless otherwise stated.

Terms used in the present disclosure are only used to describe specific embodiments, and are not intended to limit the present disclosure. Expressions in the singular form include the meaning of the plural form unless they clearly mean otherwise in the context. In the present disclosure, expressions such as “comprise” or “have” are intended to mean that the described features, numbers, steps, operations, components, parts, or combinations thereof exist, and should not be understood to be intended to exclude in advance the presence or possibility of addition of one or more other features, numbers, steps, operations, components, parts, or combinations thereof.

Unless specifically defined otherwise, all terms used herein, including technical or scientific terms, have a meaning consistent with the meaning commonly understood by a person having ordinary skills in the technical field to which the present disclosure belongs. Terms defined in commonly used dictionaries should be interpreted as having a meaning consistent with the meaning in the context of the related technology, and should not be construed in an ideal or overly formal sense unless explicitly defined in the present disclosure.

### CNN-Based Skeleton Action Recognition

In early skeleton-based action recognition study, conventional convolutional neural network (CNN) models were generally adopted. To utilize the CNN models, in some embodiments, pseudo images were generated by preprocessing a sequence of skeletons to three channel images. For example, after color maps of joint trajectories from three different views of front, top, and side were built, and the prediction scores of these three different views were fused. The body pose evolution image (BPI) and body shape evolution image (BSI) approaches were used by applying rank-pooling along a temporal axis of joints and concatenating normalized coordinates of 3D joints, respectively.

The weakness of pseudo image-based action recognition with skeletons is that convolutional operations are only applied to neighboring joints and represented as images on a grid. That is, although many plausible combinations of joints should be considered together, only three joints are taken into account with a convolution of a kernel size of three. To resolve this problem, in the BSI method, duplicated joints traversing along a human body are set. On the other hand, HCN was formed as a modified version of VGG-19 by creating additional layers that swap axes of joints of channels (from T×V×C to T×C×V). These swapping layers lead to significant performance improvements without additional costs, showing that non-local operations performed on a wide range of neighboring joints are important for action recognition.

A heatmap-based 3D CNN action recognition model, PoseC3D, was also introduced. The PoseC3D is a variant of a 3D CNN model that uses a 3D or (2+1)D convolutional layer to extract spatiotemporal features. A heatmap of each joint generated from 2D skeleton inputs is also used on the PoseC3D. When using the PoseC3D, the issue of locality may be resolved by stacking deep blocks of 3D layers to extract spatiotemporal features. However, as the PoseC3D is deep, it incurs a higher computational cost than GCN-based models. In addition, it was proven that the PoseC3D models may be more robust against failures in joint detection than the GCN-based models.

### GCNs for Skeleton Action Recognition

From the observations regarding the variants of the CNN-based methods above, it is inferred that the action recognition with the GCNs based on the concept of “adjacency of neighboring joints” may perform better than the conventional CNN-based methods.

The original GCN was modified as a spatiotemporal GCN (ST-GCN) and then used for action recognition for the first time. After the ST-GCN was proposed, many other similar methods have been explored. The ST-GCN, an extension to the GCN, was developed by a subset partitioning method to divide neighboring joints into groups in a spatial domain, and a 1D convolutional layer was used to capture dynamics of each joint in a temporal domain. In the adaptive GCN (AGCN) and the adjacency-aware GCN (AAGCN), learnable adjacency matrices may be made by applying outer products of intermediate features and combining them.

In the case of MS-G3Ds, an adjacency matrix may be extended to an additional dimension in temporal directions so that more comprehensive ranges of spatiotemporal nodes may be captured compared to spatial relations. Inspired by Shift-CNNs, Shift-GCNs were formed by a shifting mechanism instead of utilizing an adjacency matrix to aggregate features. In the case of Efficient-GCNs, to use less parameters for computation, separable convolutional layers were embedded, and an early fusion method was adopted for input data streams. In particular, by adopting the early fusion, the number of model parameters for multistream ensembles was dramatically reduced. Unlike other GCN models, in the case of Distance-GCNs, a new adjacency matrix was created based on Euclidean distances between joints, and it was proven that using pairwise distances between joints may yield the improvement of action recognition performance compared to simply using adjacency of being physically connected.

In the previous research on the GCNs for action recognition, it is seen that designing an adjacency matrix may have a critical effect on the performance. As an improved version of the Distance-GCNs, according to the embodiments of the present disclosure, actual metrics may be adopted to partition neighborhood joints, and technical means in which neighboring joints are sorted in order according to their distances from a joint of interest may be proposed.

FIG. 2 shows the whole model structure for the action recognition using the rank graph convolutional networks according to the embodiments of the present disclosure. As in the GCN-based action recognition models, the Rank-GCN according to the embodiments of the present disclosure may be formed using a similar feature of ten blocks of interleaving spatial graph convolutional layers and temporal 1D convolutional layers with three channel stages. Here, a Rank-GCN layer may be used for spatial convolution.

First, a frame including a skeleton 210 for motions of an object may be input. The size of the input data may be P×T×V×C, where P represents the number of people in sequence, T represents the number of frames, V represents the number of joints, and C represents a dimension of 2D or 3D coordinates. When a graph represented with the adjacency matrix A, which could be a predefined fixed graph that may be possibly modified with an attention mechanism or constructed experimentally, is given, multiple blocks of a spatial graph convolutional layer and a 1D temporal convolutional layer may be applied to the input data to extract high-dimensional spatiotemporal features 220. In particular, spatiotemporal features may be extracted using a rank adjacency matrix where a distance between one node and another node and an adjacency ranking may be considered with respect to a skeleton. Here, the process of extracting the spatiotemporal features may be performed by a module 220 including at least one spatial graph convolutional layer and at least one temporal convolutional layer in FIG. 2, and, for example, may be performed by a module consisting of three channel stages, each of which consists of four blocks, three blocks, and three blocks of the spatial graph convolutional layers and the temporal convolutional layers, including a total of 10 blocks.

Then, based on the extracted spatiotemporal features, objects (e.g., a person) in the input frame and vertices of the objects may be merged. To this end, the global averaging pooling (GAP) 230 may be applied. In the last stage, a classification task may be carried out. To this end, the softmax 240 may be applied.

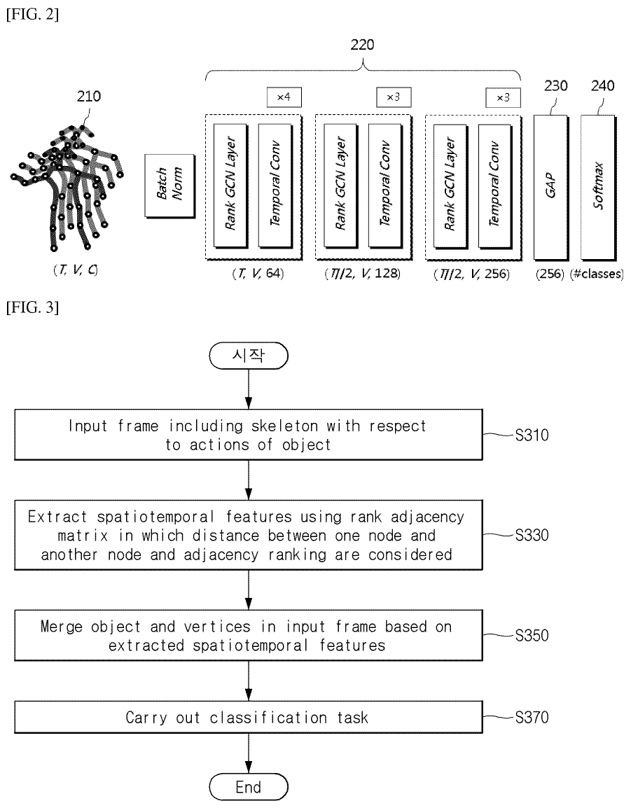

FIG. 3 is a flowchart illustrating a method of processing actions based on a graph convolutional network (GCN) according to an embodiment of the present disclosure.

In step S310, an action processing device may receive a frame including a skeleton with respect to actions of an object.

In step S330, the action processing device may extract, with respect to the skeleton, spatiotemporal features by using a rank adjacency matrix in which a distance between one node and another node and an adjacency ranking may be considered. In this process, rank-based adjacency, not based solely on the structure of the skeleton, may also be considered in addition to 1-hop connection relationships or distances of nodes (or vertices) of which the skeleton consists. There may be proposed an approach in which, even when body parts that are far from each other due to the structure of the human body are adjacent to each other (for example, the hand and mouth are adjacent to each other), nodes are arranged in order of adjacency according to their distances and a certain number of nodes are identified as adjacent nodes. This process may be performed by a module including at least one spatial graph convolutional layer and at least one temporal convolutional layer.

In step S350, the action processing device may merge an object and vertices in an input frame based on the spatiotemporal features extracted in step S330.

In step S370, the action processing device may carry out a classification task.

A spatial graph convolution operation for extracting the spatiotemporal features in step S330 described above may be formulated as the following equation:

$$\\ \begin{matrix}{v}_{i , out} = {\sum }_{{v}_{j} ∈ 𝒩 ( {v}_{i , old} )} FC ( {v}_{j , {}_{} in} ) \cdot {A}_{ij} & [ Equation 1 ]\end{matrix}$$

Here, v, A, N, and FC( ) respectively represent a vertex, adjacency matrix, neighboring node-set, and fully-connected layer.

As illustrated in FIG. 2, the rank graph convolutional network (Rank-GCN) model according to the embodiments of the present disclosure may consist of 10 interleaving rank graph convolutional layers for spatial features and a 1D convolutional layer for temporal features. The rank graph convolutional layers may extract spatiotemporal features in addition to the spatial features according to an input stream and an adjacency matrix to obtain a more complex representation of body gestures.

FIG. 4 is a view illustrating a comparison of various methods of defining neighboring neighbors in order to explain the concept of “ranking” according to the embodiments of the present disclosure, and a vertex of interest is indicated by a black node therein.

FIG. (a) of FIG. 4 shows a method that can be used for the ST-GCN, AGCN, and AAGCN, and X represents a virtual node. In the case of the method in FIG. (a) of FIG. 4, nodes within a dotted line may be defined in advance and used as nodes adjacent to a vertex of interest (black node), and, in this case, coverage of local neighbors may be very limited because only physically connected 1-hop neighbors may be considered. On the other hand, in the methods shown in FIGS. (b) and (c) of FIG. 4, a wide range of neighbors may be handled.

FIG. (b) of FIG. 4 shows the Distance-GCN method, and D1 and D2 in FIG. (b) represent the radii of concentric circles centered on the node of interest. FIG. (c) of FIG. 4 shows the rank-GCN method according to the embodiments of the present disclosure. Neighboring nodes may be dynamically defined based on their distance from the vertex of interest (black node), and it was proven that the action recognition performance may be improved in terms of accuracy and stability when adjacency is calculated based on the information on the rankings in order of adjacency.

Comparing FIGS. (b) and (c) of FIG. 4, the solid circle with radius D1 and the dotted circle with radius D′1 in FIG. (b) are two possible ranges for some subsets. Two of the three joints may be excluded when the subsets have a “slightly” smaller range learned in the training process such as the dotted circle. This may affect the performance because the number of elements (joints) has been changed. In the case of the method shown in FIG. (c) of FIG. 4, the ranking strategy is adopted so that a stable number of elements for each subset may be maintained without being affected by slight changes in distance of neighboring nodes. When comparing nodes within distance D′1, an instability problem may occur in the method shown in FIG. (b) of FIG. 4, whereas the Rank-GCN partition group shown in FIG. (c) of FIG. 4 may be stable.

Hereinafter, the rank graph convolutional layer module, which is the main module of the Rank-GCN for graph-based action recognition, will be described with reference to FIGS. 4 to 6.

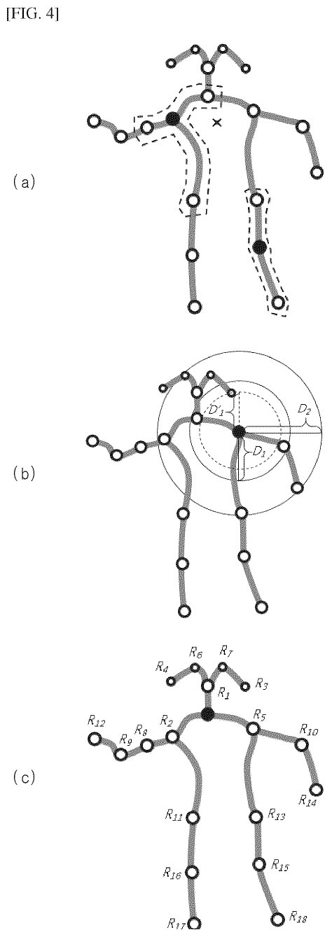

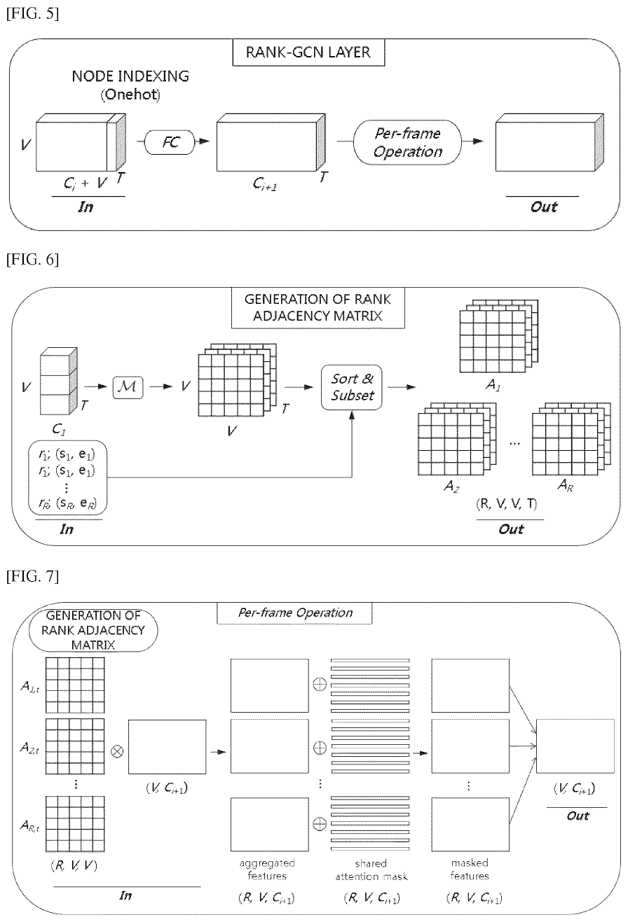

FIG. 5 is a view showing the rank graph convolutional layer of the action recognition model in FIG. 2 in more detail.

In the case of the spatial graph convolutional layer according to the embodiments of the present disclosure, node indexing may be performed along a feature channel axis, a fully-connected layer may be applied, vertices may be aggregated using a rank adjacency matrix, and an attention mask shared between frames may be applied.

### Node Indexing

Conventional GCNs for action recognition aggregate joint features with fixed rules so that it can be expected which nodes will be aggregated at a given point. However, when the aggregation is carried out dynamically, there may be no fixed set of aggregated joints. To address this problem, the embedding of one-hot vertex indices may be added along a feature channel axis, so that it may be possible to aggregate joint features dynamically.

### Rank Adjacency Matrix

FIG. 6 is a view for explaining a process of generating a rank adjacency matrix.

To capture action dynamics more effectively, a new method of generating an adjacency matrix, the rank adjacency matrix, is proposed. When a frame at time t and a center node vⁱₜ of interest are given, distance between nodes may be calculated based on the metric function M that outputs scalar values. The distance matrix Dⁱₜ, may be obtained by iterating over all nodes in an input frame as follows:

Dⁱₜ={ [symbol] (vⁱₜ, v^{j}ₜ)|j=1, . . . , V}∈ [symbol] ^{v×1}. [Equation 2]

where vⁱₜ , may represent coordinate, speed, and acceleration of a vertex.

Based on the distance matrix, a rank matrix, Aₜᵢ∈ [symbol] ^{R×V×}1, may be derived by ranking and filtering them with rank range, Γ={yᵣ=(sᵣ, eᵣ)|r=1, . . . , R}, where sᵣ and eᵣ represent the start and end of the range, respectively, and R represents the number of rank ranges. Hence, the ranking metric at a frame t for a vertex i and a rank r may be as follows:

A_{t,r}ⁱ=filter(rank(Dⁱₜ), γᵣ)∈{0,1}^{V×1} [Equation 3]

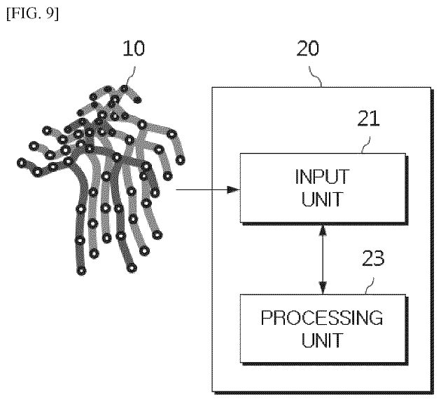

When input skeletons are given, the frames of the skeletons may be represented by S={Sᵢ∈ [symbol] ^{V×C}|t=1, . . . , T}. The rank graph convolutional layer may work according to the algorithm presented in FIG. 9.

FIG. 7 shows in more detail the frame-by-frame operation process of the rank graph convolutional layer in FIG. 5 and a method of aggregating vertices based on a given rank adjacency matrix and applying an attention mask shared between frames.

As shown in Equations 2 and 3 above, the rank adjacency matrix may generate a matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric. In terms of matrix generation, the rank adjacency matrix may generate a distance matrix by calculating a Euclidean distance between one node and another node for all nodes in an input frame, and may generate a matrix in which an adjacency ranking is obtained by ranking and filtering nodes based on a ranking metric in which a rank range is set based on the generated distance matrix.

### Rank-wise Attention Mask

As the performance in many aspects was boosted by attention mechanisms, a new attention module was devised. For example, although the attention mechanisms may be applied on adjacency matrices or aggregated features, attention may be applied in the pre-aggregation stage according to the embodiments of the present disclosure, which makes it possible to learn an optimal mask for each rank subset. To make an attention module as light as possible, a simple static multiplication mask, which is denoted as M in Alg. 1, may be adopted. The mask module may be a rank-, vertex-, and channel-wise multiplication mask, which results in consistent performance improvements with only slight increase in computational complexity and the number of weight parameters. In summary, the attention mask may learn a mask for each rank subset by applying attention before feature aggregation, but may apply the static multiplication mask as an attention mask shared between frames.

By combining the modules described above, there is proposed a Rank-GCN layer that aggregates features differently for each frame according to input skeleton data. The entire process of the Rank-GCN layer is presented in the algorithm in FIG. 9. Here, the rank matrix A may be utilized in various forms by changing the metric function [symbol] .

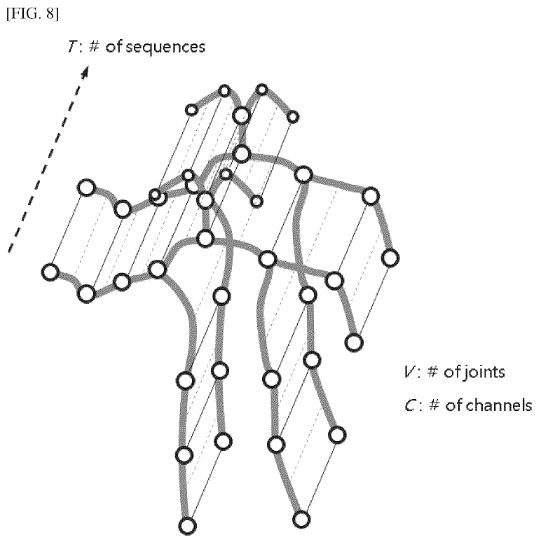

FIGS. 8 and 9 are views for explaining a process of performing the rank graph convolutional layer and for illustrating pseudocodes, respectively. Here, T represents the number of sequences, V represents the number of joints, and C represents the number of channels. FIG. 9 shows a graph convolution algorithm in which the adjacency matrix A may be calculated based on a rank with the shortest distance and features used for action recognition may be extracted based on the calculation.

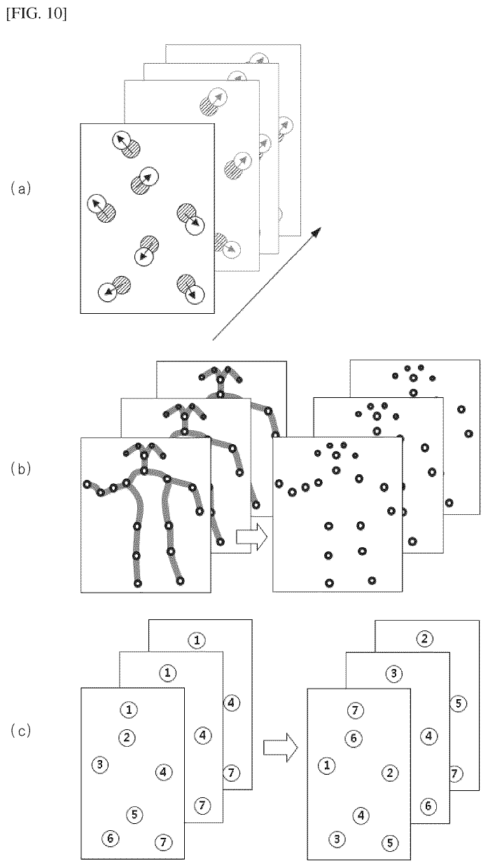

FIG. 10 is a block diagram showing the action processing device 20 based on the graph convolutional network according to an embodiment of the present disclosure, and is a reconstruction of the method of processing actions in FIG. 3 in terms of hardware. Therefore, in order to avoid repetition of the description, only the outline of operations and functions of the components will be briefly described below.

An input unit 21 may be a component for receiving a frame including a skeleton 10 with respect to actions of an object.

A processing unit 23 may be a component for processing actions in a frame using the graph convolutional network (GCN), and may extract spatiotemporal features with respect to a skeleton by using a rank adjacency matrix in which a distance between one node and another node and an adjacency ranking are considered, merge an object and vertices in the input frame based on the extracted spatiotemporal features, and perform a classification task.

The processing unit 23 may extract spatiotemporal features using a module including at least one spatial graph convolutional layer and at least one temporal convolutional layer, and the spatial graph convolutional layer may perform node indexing along a feature channel axis, apply a fully-connected layer, aggregate vertices using a rank adjacency matrix, and apply an attention mask shared between frames.

The processing unit 23 may generate a rank adjacency matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric. More specifically, the processing unit 23 may generate a distance matrix by calculating a Euclidean distance between one node and another node for all nodes in an input frame, and may generate the rank adjacency matrix for obtaining an adjacency ranking by ranking and filtering nodes based on a ranking metric in which a rank range is set based on the generated distance matrix.

The processing unit 23 may dynamically aggregate joint features by performing one-hot embedding of vertex indices along a feature channel axis. In addition, the processing unit 23 may learn a mask for each rank subset by applying attention before aggregating the features, and may apply a static multiplication mask as an attention mask shared between frames.

A powerful skeleton-based action recognition method based on the new adjacency matrix named Rank-GCN has been proposed according to the above-described embodiments of the present disclosure. The Rank-GCN may be a method of creating an adjacency matrix to accumulate features of adjacent nodes by redefining the concept of “adjacency.” The new adjacency matrix, called a rank adjacency matrix, may be generated by ranking all nodes according to a metric involving Euclidean distances from a node of interest. Such a method is differentiated from the GCN method, which uses only 1-hop neighboring nodes to build adjacencies.

In the following, there are presented the results of experiments and analyses for combining different metric functions with different input streams to see whether their resulting models are complementary. The following three data sets were used in the experiments.

First, NTU RGBCD 60 is a data set containing four different modalities of RGB, depth maps, infrared rays, and 3D skeleton data. This contains 56,880 samples with 40 subjects, 3 camera views, and 60 actions. Two official benchmark training-test splits are used: cross-subject (CS) and cross-view (CV). The data set also contains 3D RGB, depth maps, and 2D skeletons projected in infrared. The 3D skeleton data is displayed in meters. All modalities are captured by the Kinects-V2 sensor, and the 3D skeleton is inferred from the depth map. Due to limitations of the depth map and ToF sensor, there is a lot of noise in the coordinates of some samples' skeletons. The sample length is up to 300 frames, and the number of people in the view is up to four people. A sample with the two most active people and 300 frames is selected. Samples with less than 300 frames or less than two people are preprocessed by the method used for the AAGCN.

Second, NTU RGBCD 120 is an extended version of the NTU RGBCD 60 with the addition of 60 new working classes. Two official benchmark training-test splits are used: cross-set (XSet) and cross-subject (XSub). The preprocessing method used for the NTU RGBCD 60 is also applied here.

Third, Skeletics-152 is a data set of skeletons' actions extracted from the Kinetics 700 data set by the VIBE pose predictor. Because the Kinetics-700 contains both actions that are not created by humans and actions that need to be classified within the context of human interaction, 152 classes out of a total of 700 classes are selected for the Skeletics-152. Since the VIBE pose predictor is capable of accurately predicting poses, the Skeletics-152's skeletons have much less noise than the NTU-60′s skeletons. The number of people in a sample ranges from 1 to 10, with a mean of 2.97 and a standard deviation of 2.8. The sample length ranges from 25 frames to 300 frames, with an average of 237.8 and a standard deviation of 74.72. A maximum of two people are selected from samples for all performed experiments. While the NTU-60 contains joint coordinates in meters, the Skeletics-152 has normalized values in the range [0,1]. Samples with less than 300 frames or less than three people are filled with zeros, and no additional preprocessing is carried out for training and testing.

To demonstrate the robustness of the Rank-GCN method according to the embodiments of the present disclosure, three different experimental settings were designed and visualized as shown in FIG. 11. FIG. (a) of FIG. 11 shows a random translation, figure (b) shows random dropping of joints, and figure (c) shows random swapping of joints, and all modifications are made in a frame manner.

The experiment on the CS segmentation of the NTU RGBCD 60 data set was performed. Although the accuracy in predicting poses has improved, misalignment between inferred joints can still occur. The Kinects V2, a capture device used for the following experiment, has a problem with frequent shaking. In this experiment, only joint streams are used, and no ensemble of streams is used. For comparison, the MS-G3D is selected as an upper version of the proposed model, and the AAGCN is selected as a lower version. Concerned that a good model may be vulnerable to various errors, the AAGCN is set as a comparison model.

For the random translation experiment, all joints are transformed into vectors having the same length but different directions. The uniformly transformed vectors in the range [0, 1] are applied to all frames and all joints in each frame. Here, 1 is the maximum length of the transformed vectors. FIGS. 12 and 13 show the results of the random translation experiments.

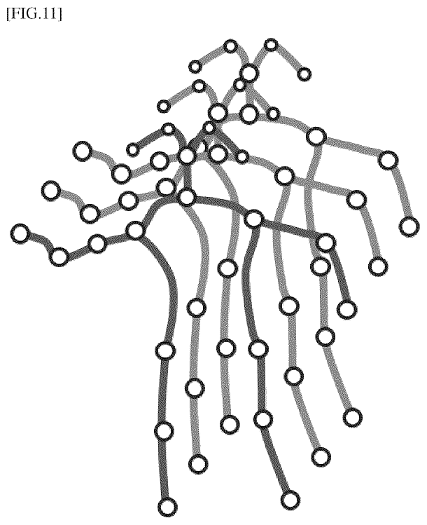

In the experiments on random dropping of vertices, it is assumed that inference about subsets of joints fails due to occlusion or an error in a system for predicting poses. Out of a total of 25 joints, d joints are selected, and the selected joints are set to (0,0,0) with a probability of 0.5. As shown in FIGS. 14 and 15, the experiments are performed under the settings of d=0, 1, 2, 3, 4, and 5. It was confirmed that the Rank-GCN model according to the embodiments of the present disclosure outperforms other models when an arbitrary joint is dropped, and the results of the experiments suggest that the Rank-GCN model is more robust than other models in harsh environments where models for recognizing actions of joints do not have access to a subset of partial joints.

In the experiments on random swapping of vertices, all joints are replaced in random order. For each instance of the test, the length of the permutation sequence 1 is changed from 0 to 300 using a random starting point. The results in FIG. 16 show that, unlike the other two robustness tests, the performance of the AAGCN is rapidly degraded. This means that, while the generation of instance-by-instance adjacency matrices by the AAGCN has detrimental consequences, permutation joints are handled very well in the approach based on a dynamic rank adjacency matrix by the Rank-GCN models. However, FIG. 17 shows that, in the case of multiple streams, the Efficient-GCN is superior to the Rank-GCN. It was assumed that the architecture of the Efficient-GCN is more suitable for this experiment than the Rank-GCN method because of the preprocessing strategy of the Efficient-GCN.

According to the embodiments of the present disclosure described above, there has been proposed the Rank-GCN in which a rank adjacency matrix is derived based on a distance between one node and other nodes and an adjacency ranking in order to apply a GCN architecture to action recognition. The Rank-GCN may be a method in which a rank adjacency graph is defined based on pairwise distances between vertices and vertex features are accumulated according to a rank with the shortest distance and a rank with the longest distance. As a result, in the case of the Rank-GCN, not only the accuracy in action recognition may be improved, but also the robustness for swapping, moving, and dropping of a specific node may be secured in a more practical scenario.

The embodiments according to the present disclosure may be implemented by various means such as hardware, firmware, software, or combinations thereof. When an embodiment of the present disclosure is implemented by hardware, it may be implemented by one or more of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc. When an embodiment of the present disclosure is implemented by firmware or software, it may be implemented in the form of a module, procedure, function, etc. that has the above-mentioned capabilities or performs the above-mentioned operations. The software code may be stored in a memory and run by a processor. The memory may be located inside or outside the processor and exchange data with the processor by various means known in the art.

Meanwhile, it may be possible to implement the embodiments of the present disclosure with computer readable codes on a computer readable recording medium. Examples of the computer readable recording media may include all types of recording devices in which data that can be read by a computer system is stored. Examples of the computer readable recording media may include a ROM, RAM, CD-ROM, magnetic tape, floppy disk, device for storing optical data, etc. In addition, the computer readable recording medium may be distributed to computer systems connected through a network, so that the computer readable codes may be stored and executed in a distributed manner. Furthermore, functional programs, codes, and code segments for implementing the embodiments of the present disclosure may be easily derived by programmers in the technical field to which the present disclosure pertains.

There may be provided one or more non-transitory computer-readable media storing one or more instructions, wherein the one or more instructions executable by one or more processors may process actions using the graph convolutional network (GCN), receive a frame including a skeleton with respect to actions of an object, extract spatiotemporal features with respect to the skeleton by using a rank adjacency matrix in which a distance between one node and another node and an adjacency ranking are considered, merge an object and vertices in the input frame based on the extracted spatiotemporal features, and perform a classification task. Here, the rank adjacency matrix may generate a matrix in which: a distance between one node and another node is calculated for all nodes representing joints in the input skeleton data; nodes are sorted in ascending order of the calculated distances; and a predetermined number of nodes adjacent to the one node are ranked in order of adjacency by a ranking metric.

As shown above, the present disclosure has been examined focusing on its various embodiments. A person having ordinary skills in the technical field to which the present disclosure belongs will be able to understand that the various embodiments can be implemented in modified forms within the scope of the essential characteristics of the present disclosure. Therefore, the disclosed embodiments are to be considered illustrative rather than restrictive. The scope of the present disclosure is shown in the claims rather than the foregoing description, and all differences within the scope should be construed as being included in the present disclosure.

What is claimed is:

1. A method of processing actions based on a graph convolutional network (GCN), comprising:
a step in which an action processing device receives a frame including a skeleton with respect to actions of an object;
a step in which the action processing device extracts spatiotemporal features with respect to the skeleton by using a rank adjacency matrix in which a distance between one node and another node and an adjacency ranking are considered;
a step in which the action processing device merges an object and vertices in the input frame based on the extracted spatiotemporal features; and
a step in which the action processing device performs a classification task.

2. The method of processing actions of claim 1,
wherein the step of extracting the spatiotemporal features is carried out by a module including at least one spatial graph convolutional layer and at least one temporal convolutional layer, and
the spatial graph convolutional layer performs node indexing along a feature channel axis, applies a fully-connected layer, aggregates vertices using a rank adjacency matrix, and applies an attention mask shared between frames.

3. The method of processing actions of claim 2, wherein the rank adjacency matrix generates a matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric.

4. The method of processing actions of claim 3, wherein the rank adjacency matrix generates a distance matrix by calculating a Euclidean distance between one node and another node for all nodes in an input frame and generates a matrix in which an adjacency ranking is obtained by ranking and filtering nodes based on a ranking metric in which a rank range is set based on the generated distance matrix.

5. The method of processing actions of claim 2, wherein, in the node indexing, the embedding of one-hot vertex indices is performed along a feature channel axis to aggregate joint features dynamically.

6. The method of processing actions of claim 2, wherein the attention mask learns a mask for each rank subset by applying attention before aggregating features and applies a static multiplication mask as an attention mask shared between frames.

7. The method of processing actions of claim 2, wherein the step of extracting spatiotemporal features is performed by a module consisting of three channel stages, each of which consists of four blocks, three blocks, and three blocks of a spatial graph convolutional layer and a temporal convolutional layer, including a total of 10 blocks.

8. The method of processing actions of claim 1, wherein the step of merging an object and vertices in an input frame is performed by the global averaging pooling (GAP), and the step of performing a classification task is carried out by applying the softmax.

9. One or more non-transitory computer-readable media storing one or more instructions, wherein the one or more instructions executable by one or more processors process actions using a graph convolutional network (GCN), receive a frame including a skeleton with respect to actions of an object, extract spatiotemporal features with respect to the skeleton by using a rank adjacency matrix in which a distance between one node and another node and an adjacency ranking are considered, merge an object and vertices in an input frame based on the extracted spatiotemporal features, and perform a classification task.

10. The computer-readable media of claim 9, wherein the rank adjacency matrix generates a matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric.

11. An action processing device comprising:
an input unit receiving a frame including a skeleton with respect to actions of an object; and a processing unit processing actions in the frame by using a graph convolutional network (GCN),
wherein the processing unit extracts spatiotemporal features with respect to the skeleton by using a rank adjacency matrix in which a distance between one node and another node and an adjacency ranking are considered, merges an object and vertices in an input frame based on the extracted spatiotemporal features, and performs a classification task.

12. The action processing device of claim 11,
wherein the processing unit extracts the spatiotemporal features using a module including at least one spatial graph convolutional layer and at least one temporal convolutional layer, and
the spatial graph convolutional layer performs node indexing along a feature channel axis, applies a fully-connected layer, aggregates vertices using a rank adjacency matrix, and applies an attention mask shared between frames.

13. The action processing device of claim 12, wherein the processing unit generates the rank adjacency matrix in which: a distance between one node and another node is calculated for all nodes representing joints in input skeleton data; nodes are sorted in ascending order of the calculated distances; and a predetermined number of nodes adjacent to the one node are ranked in order of adjacency by a ranking metric.

14. The action processing device of claim 13, wherein the processing unit generates a distance matrix by calculating a Euclidean distance between one node and another node for all nodes in an input frame and generates the rank adjacency matrix for obtaining an adjacency ranking by ranking and filtering nodes based on a ranking metric in which a rank range is set based on the generated distance matrix.

15. The action processing device of claim 12, wherein the processing unit aggregates joint features dynamically by performing the embedding of one-hot vertex indices along a feature channel axis.

16. The action processing device of claim 12, wherein the processing unit learns a mask for each rank subset by applying attention before aggregating features and applies a static multiplication mask as an attention mask shared between frames.
